(19) United States
(12) Patent Application Publication
(10) Pub. No.: US 2023/0277007 A1
(43) Pub. Date: Sep. 7, 2023

(54) TOOL FOR HOLDING AND ROASTING CYLINDRICAL SHAPED FOODS

(71) Applicant: Jeff A. Roste, Alexandria, MN (US)

(72) Inventor: Jeff A. Roste, Alexandria, MN (US)

(21) Appl. No.: 18/175,025

(22) Filed: Feb. 27, 2023

Related U.S. Application Data
(60) Provisional application No. 63/268,737, filed on Mar. 1, 2022.

(51) Int. Cl. A47J 43/18; A47J 43/28

(52) U.S. Cl. CPC A47J 43/18; A47J 43/283; A47J 33/00

(57) ABSTRACT

A tool for holding and roasting a hot dog including a handle having a grip end, a shaft, and a roasting end is disclosed. The roasting end includes a central section and a pair of projections extending from the central section, with each projection comprising a substantially linear attachment portion connected to the central section. Each projection further comprises a receiving portion, consisting of a generally annular cross-section defining a first surface and a second surface, wherein the first surface and the second surface are substantially concentric. The receiving portion also includes a slot extending between the first surface and the second surface, with the slot bisecting the receiving portion of the projection. The attachment portion of each projection is angularly offset from a longitudinal axis of the grip end of the handle, and the receiving portion is angularly offset from an axis extending through the attachment portion.

This application claims priority to U.S. Provisional Application, Ser. No. 63/268,737, filed Mar. 1, 2023, and titled “TOOL FOR HOLDING AND ROASTING CYLINDRICAL SHAPED FOODS,”

### BACKGROUND OF THE INVENTION

### Field of the Invention

The disclosure relates generally to the field of cooking utensils. More specifically, the disclosure relates to tools to facilitate the roasting of sausages such as hot dogs or other cylindrical shaped food items.

### Description of the Related Art

Long pointed sticks have long been used for roasting food such as sausages over an open fire. Sausages pierced by and supported on a stick tend to rotate on the stick with a heavier end rotating downward. If care is not taken, the sausage may slide off the sharpened end of the stick and into the fire and ashes. Long handled forks which pierce the sausage in at least two spots prevent unwanted rotation, but sausages are still prone to slide off the end of the fork. Piercing of a sausage with a stick or fork also allows juices to escape from the sausage casing reducing the quality of the roasted sausage. The sharp ends of sticks or forks used to hold hot dogs warrant close monitoring of their use by children to prevent injury.

### SUMMARY OF THE INVENTION

In an embodiment of the invention, a tool for holding and roasting cylindrical shaped foods comprises a handle having a hand grip end and a roasting end. The tool includes at least one annular gripper mounted on the roasting end of the handle, the annular gripper forming a receiver sized to receive and hold a portion of a first sized cylindrical shaped food item therein.

The annular gripper is formed from a flexible material, and the annular gripper includes a slit extending through one end, such that the annular gripper comprises first and second arcuate legs. The annular gripper having a slit may also be described as having a split ring shape. Typically, the slit is located on an end opposite the shaft, and the arcuate legs are of approximately equal arc lengths. These arcuate legs are biasable outward to increase the size of the receiver formed therebetween to receive and hold a portion of a cylindrical shaped food item. The increase in receiver size allows for larger diameter foods to be held by the annular grippers.

In another embodiment, a tool for holding and roasting cylindrical shaped foods comprises a handle having a hand grip end, a shaft and a roasting end. The tool includes a gripping assembly having first and second prongs connected to and projecting outward from the shaft at the roasting end of the handle. First and second grippers are mounted on the first and second prongs respectively, and each of the first and second grippers has a receiver formed therein sized to receive and hold a portion of a cylindrical shaped food item. Each gripper is preferably formed as an expandable, split ring to accommodate food items of varying diameter or cross-section.

### BRIEF DESCRIPTION OF THE DRAWINGS

Illustrative embodiments of the present invention are described in detail below with reference to the attached drawing figures.

FIG. 1 is a perspective view of a hot dog roasting tool according to an embodiment of the invention.

FIG. 2 is a fragmentary side view of the hot dog roasting tool of FIG. 1.

FIG. 3 is an enlarged and fragmentary perspective view of a roasting end of the hot dog roasting tool of FIG. 1.

FIG. 4 is an enlarged and fragmentary top view of the hot dog roasting tool of FIG. 1.

FIG. 5 is an enlarged and fragmentary side view of the hot dog roasting tool of FIG. 1.

### DETAILED DESCRIPTION

Certain terminology will be used in the following description for convenience in reference only and will not be limiting. For example, the term “hot dog” may refer to any number of cylindrically-shaped consumable food products, such as hot dogs, sausages, bratwursts, and any other variations known by those in the art.

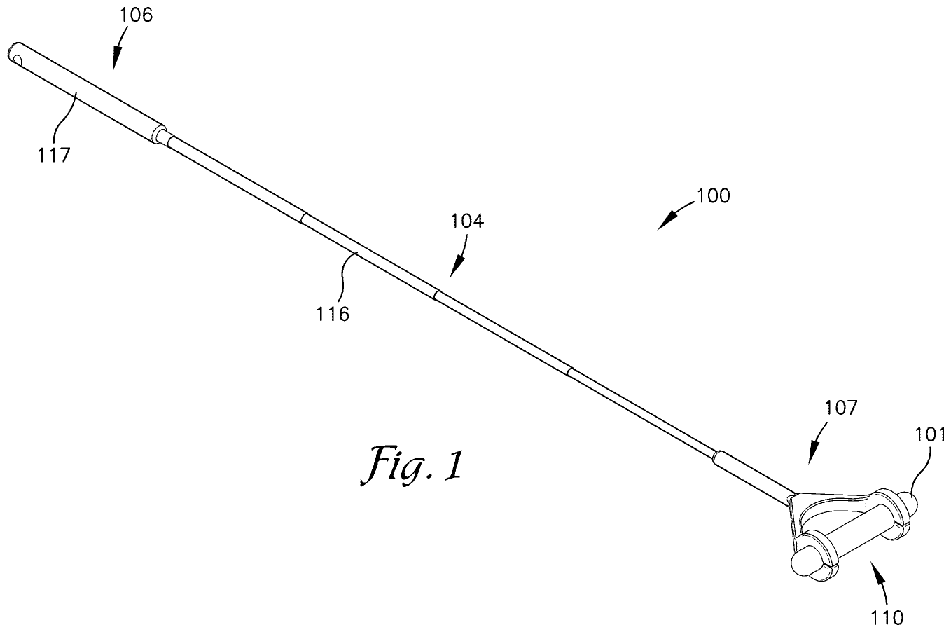

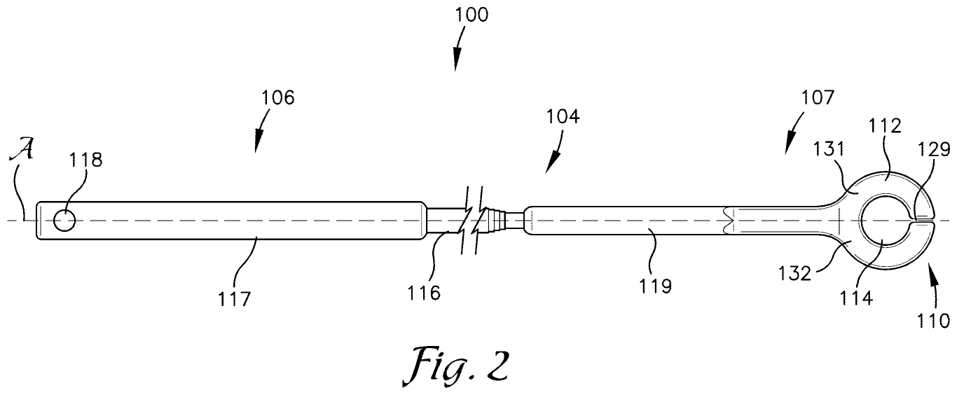

An embodiment of a tool 100 for roasting cylindrical shaped food items 101 of varying sizes such as hot dogs and other types of sausages is shown in FIGS. 1-5. The roasting tool 100 includes an elongate handle 104 having a hand grip end 106 and a roasting end 107 and a gripping assembly 110 connected to the handle 104 at the roasting end 107 thereof. In the embodiment shown, the gripping assembly 110 includes two annular grips or grippers 111 and 112 each having a receiver 114, in the form of a hole or opening, formed therein sized to receive and hold a portion of a food item 101 which can then be held over a heat source, such as an open flame, to facilitate cooking of the food item 101. It is foreseen that a single, appropriately sized annular grip may be utilized to hold a food item. It is also foreseen that the receivers could be formed as hollows or sockets in cup shaped grippers.

In the illustrated embodiment, the handle 104 includes a rod or shaft 116. Shaft 116 may be formed from metal, preferably aluminum, but may be constructed from other metals or other rigid materials such as fiberglass which are not susceptible to failure or deformation when exposed to extreme heat. In some embodiments, it may be desirable to vary the length or angle of the handle 104. This may be advantageous for storage, as a collapsible or foldable handle may have a smaller footprint. The handle 104 and shaft 116 therefore may be formed as a telescoping or folding assembly as desired.

A handle grip 117 may be formed at the grip end 106 of the handle 104 to improve ergonomics and/or reduce the temperature of the grip end 106. A through hole 118 may be formed through handle 104, handle grip 117 or both the handle grip 117 and the handle 104. to permit the handle 104 the be hung vertically, either for storage purposes or for commercial display. The handle grip 117 may be formed from a flexible polymeric material, for example silicone, and may be molded over the rigid rod 116. In the preferred embodiment, the handle grip 117 is formed from a food-safe FDA-approved silicone material.

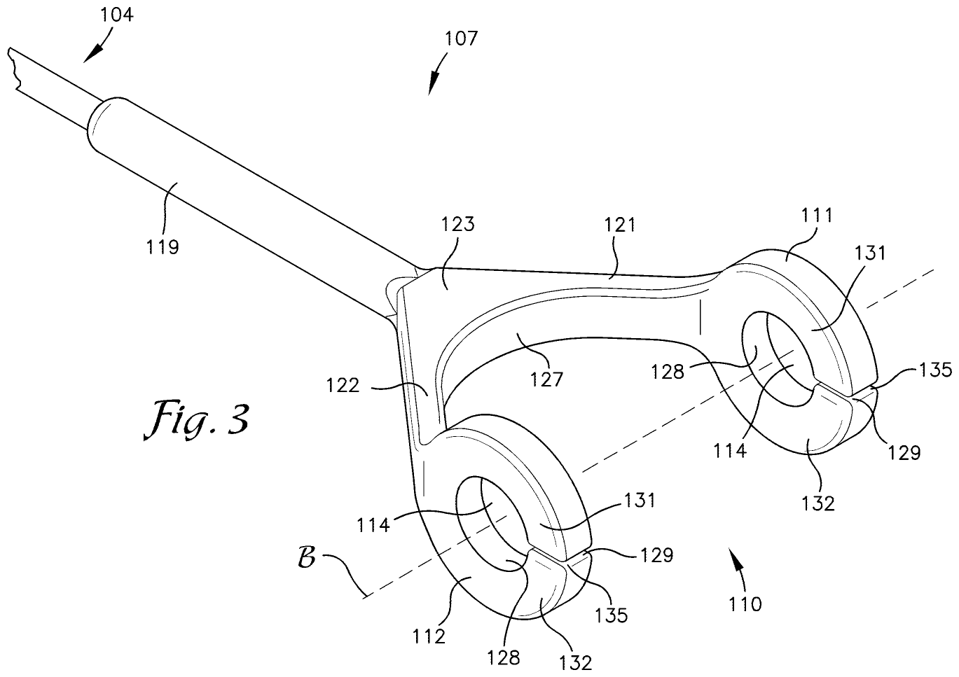

FIG. 3 shows the gripping assembly 110 mounted on the roasting end 107 of the handle 104. The gripping assembly 110 includes a hosel 119, first and second arms or prongs 121 and 122 and the first and second annular grips or grippers 111 and 112. The gripping assembly 110 is preferably formed from a heat-resistant flexible polymeric material such as a food-safe silicone. The gripping assembly 110 may be molded onto the roasting end 107 of the handle 104 with the roasting end 107 extending into the hosel 119.

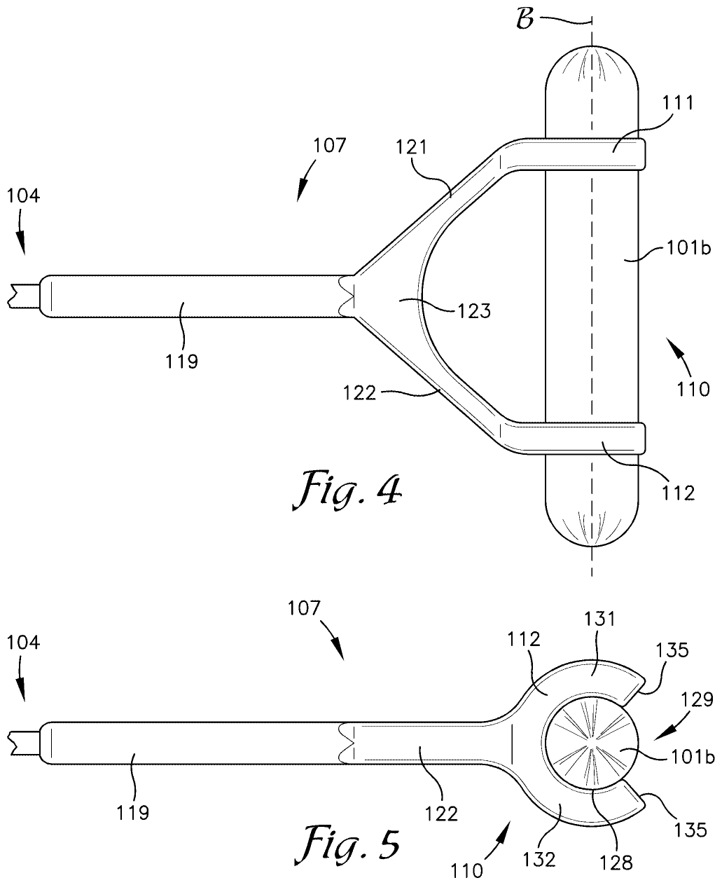

In the embodiment shown, the arms 121 and 122 extend outward from the hosel 119 at an acute angle relative to a longitudinal axis A extending through the handle 104. The arms or prongs 121 and 122 may be described as forked or forming a forked gripping assembly 110. The annular grips 111 and 112 are also shown as offset from the arms 121 and 122, respectively. In some embodiments, it may be desirable for the grippers 111 and 112 to be offset at an angle supplementary to the arms 121 and 122, such that the grippers 111 and 112 each extend in a plane that is substantially parallel to the longitudinal axis A. As shown in FIG. 4, the grippers 111 and 112 are preferably oriented collinear along an axis B which is substantially perpendicular to the handle 104 and longitudinal axis A. In other embodiments not shown, it may be desirable for the grippers 111 and 112 to be offset from the arms 121 and 122 at a non-supplementary angle. This may facilitate holding by the grippers 111 and 112 of non-linear consumable food products which have a circular cross section, such as curved sausages or other similar products.

Likewise, it may be desirable in some embodiments to be able to manually alter the angle of the arms 121 and 122 and/or grippers 111 and 112 relative to the handle on an as-needed basis, including the angular offset. This may be achieved via different materials and/or by varying the thickness of the arms 121 and 122 such that they are more elastic, which may provide a more adjustable angle for the grippers 111 and 112 that conforms to a wider variety of possible foods. The angular offset of each arm 121 and 122 and/or gripper 111 and 112 may be individually biasable inward or toward the longitudinal axis A extending through the handle 104 and/or outward or away from the longitudinal axis A. Each arm 121 and 122 and/or gripper may also be individually adjustable upward toward a user and/or downward toward the ground.

In the embodiment shown, the gripping assembly 110 includes a central portion or hub 123 to which inner ends of the arms 121 and 122 and an end of the hosel 119 are connected. The arms 121 and 122 project tangentially outward from a radial face 127 of the central hub 123 on a side of the hub 123 opposite the hosel 119. The radius of the radial face 127 may vary depending on the desired level of flexibility of the arms 121 and 122.

In the embodiment shown, the grippers 111 and 112 are substantially annular in shape. The receiver 114 of each annular grip 111 and 112 is shown as a hole, opening or void which extends through its thickness. The receiver 114 of each annular grip 111 and 112 is defined or surrounded by an inner concentric surface 128 of the annular grip 111 or 112. As shown in FIGS. 1, 4, and 5, the user may insert portions of a food item 101, such as the ends of a hot dog or other sausage into and through the receivers 114, with the exterior surface of the food item 101 frictionally engaged by the inner surface 128 of each annular grip 111 and 112.

In the illustrated embodiment, a discontinuity or slit 129 is formed in each of the annular grips 111 and 112, forming what may be referred to as split rings. The slit 129 extends through the thickness of each annular grip 111 and 112, on a side of the annular grip 111 and 112 opposite its attachment to the respective arm 121 and 122. Preferably, the slit 129 bisects the respective annular grip 111 and 112 into two arcuate segments or legs 131 and 132 forming approximately equal length arcs. When the grips 111 and 112 are empty (i.e., there is no food item inserted) the slit 129 in each annular grip 111 and 112 is substantially planar in shape. In the preferred embodiment, the slit 129 is bounded by surfaces 135 of the annular grips 111 and 112, which are substantially parallel to each other when the annular grips 111 and 112 are empty.

The slit 129 and flexibility of the material forming the annular grips 111 and 112 allows for expansion of the arcuate segments 131 and 132 of the annular grips 111 and 112 to accommodate cylindrical food items 101 of a variety of diameters. For example, in FIG. 5, the arcuate segments 131 and 132 of annular grips 111 and 112 are shown expanded to hold a sausage 101b that is larger in diameter than the hot dog 101 shown in FIG. 1. The inner concentric surface 128 remains frictionally engaged with an exterior surface of the sausage 101b as the arcuate segments 131 and 132 of the annular grips 111 and 112 expand or are biasable outward to increase the size of the receiver formed therebetween to accommodate the diameter of the sausage 101b.

In the preferred embodiment, the combination of the material and the geometry of the annular grips 111 and 112 normally biases the annular grips 111 and 112 toward a closed state, whereby the width of the slit 129 is minimized. Because the annular grips 111 and 112 are biased toward the closed state, the food item 101 remains frictionally engaged with the inner surface 128 at all times, regardless of the diameter of the inserted food item.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims.

What is claimed is:

1. A tool for holding and roasting cylindrical shaped foods, comprising:
a handle having a hand grip end and a roasting end; and
at least one gripper mounted on the roasting end of the handle, the gripper forming a receiver configured to receive and hold a portion of a first sized cylindrical shaped food item therein.

2. The tool for holding and roasting cylindrical shaped foods as in claim 1, wherein the gripper is formed from a flexible material and a slit extends through the gripper such that said gripper comprises first and second arcuate legs which are biasable outward to increase the size of the receiver formed therebetween, wherein the receiver is configurable to receive and hold a portion of a second sized cylindrical shaped food item therein, wherein the second sized cylindrical shaped food item is larger in diameter than the first sized cylindrical shaped food item.

3. The tool for holding and roasting cylindrical shaped foods as in claim 2, wherein the slit is formed through the gripper on a side of the gripper opposite a shaft of the handle to which the gripper is connected such that the first and second arcuate legs are of approximately equal length arcs.

4. The tool for holding and roasting cylindrical shaped foods as in claim 1, wherein the roasting end of the handle includes a central portion to which the at least one gripper is mounted.

5. The tool for holding and roasting cylindrical shaped foods as in claim 1, wherein the gripper is formed from a flexible material and an angle of the gripper is adjustable relative to the handle.

6. The tool for holding and roasting cylindrical shaped foods as in claim 1, wherein the gripper is formed from a flexible material and comprises first and second arcuate legs that are biased toward a closed state such that an inner surface of the gripper is configured to frictionally engage an exterior surface of the first sized cylindrical shaped food item therein, and, separately, frictionally engage an exterior surface of a second sized cylindrical shaped food item therein, wherein the second sized cylindrical shaped food item is larger in diameter than the first sized cylindrical shaped food item.

7. A tool for holding and roasting cylindrical shaped foods, comprising:
a handle having a hand grip end, a shaft and a roasting end; and
a gripping assembly having first and second prongs connected to and projecting outward from the shaft at the roasting end of the handle with first and second grippers mounted on the first and second prongs, respectively, wherein each of the first and second grippers has a receiver formed therein configured to receive and hold a portion of a first sized cylindrical shaped food item therein.

8. The tool for holding and roasting cylindrical shaped foods as in claim 7, wherein the first and second grippers are formed from a flexible material such that the size of the receiver formed by the first and second grippers is expandable, the receiver configurable to receive and hold a portion of a second sized cylindrical shaped food item therein, wherein the second sized cylindrical shaped food item is larger in diameter than the first sized cylindrical shaped food item.

9. The tool for holding and roasting cylindrical shaped foods as in claim 7, wherein the gripping assembly includes a central portion having a radial face from which the first and second prongs project tangentially outward.

10. The tool for holding and roasting cylindrical shaped foods as in claim 7, wherein the first and second grippers each comprise a ring formed from a flexible material with a slit extending through the ring, such that each of said first and second grippers comprises first and second arcuate legs which are biasable outward to increase the size of the receiver formed therebetween, the receiver configurable to receive and hold a portion of a second sized cylindrical shaped food item therein, wherein the second sized cylindrical shaped food item is larger in diameter than the first sized cylindrical shaped food item.

11. The tool for holding and roasting cylindrical shaped foods as in claim 10, wherein the slit in each ring is formed through the ring on a side opposite the prong to which the ring is connected such that the first and second arcuate legs are of approximately equal length arcs.

12. The tool for holding and roasting cylindrical shaped foods as in claim 10, wherein the first and second arcuate legs are biased toward a closed state such that an inner surface of each gripper is configured to frictionally engage an exterior surface of the first sized cylindrical shaped food item therein, and, separately, frictionally engage an exterior surface of the second sized cylindrical shaped food item therein.

13. The tool for holding and roasting cylindrical shaped foods as in claim 7, wherein the gripping assembly is formed from a flexible material and is adjustable to alter an angle of each of the first and second grippers relative to the handle.

14. A tool for holding and roasting cylindrical shaped foods, comprising:
a handle having a hand grip end, a shaft and a roasting end; and
a gripping assembly having a central portion to which first and second prongs are connected, the first and second prongs projecting outward from the central portion and have first and second grippers mounted on the first and second prongs, respectively, wherein the first and second grippers are formed from a flexible material such that expandable receivers are formed therein.

15. The tool for holding and roasting cylindrical shaped foods as in claim 14, wherein the first and second grippers each comprise a slit extending through the gripper such that each of said first and second grippers comprises first and second arcuate legs that are biasable outward.

16. The tool for holding and roasting cylindrical shaped foods as in claim 15, wherein the slit in each gripper is formed through the gripper on a side opposite the prong to which the gripper is connected, such that the first and second arcuate legs are of approximately equal length arcs.

17. The tool for holding and roasting cylindrical shaped foods as in claim 14, wherein the gripping assembly is adjustable to alter an angle of each of the first and second grippers relative to the handle.

18. The tool for holding and roasting cylindrical shaped foods as in claim 14, wherein the central portion includes a radial face from which the first and second prongs project.

19. The tool for holding and roasting cylindrical shaped foods as in claim 14, wherein the expandable receivers are configurable to frictionally engage an exterior surface of a first sized cylindrical shaped food item therein, and, separately, frictionally engage an exterior surface of a second sized cylindrical shaped food item therein.

20. The tool for holding and roasting cylindrical shaped foods as in claim 19, wherein the first and second grippers each comprise first and second arcuate legs that are biased toward a closed state.
